(19) United States
(12) Patent Application Publication
(10) Pub. No.: US 2011/0105122 A1
(43) Pub. Date: May 5, 2011

(54) Method of Handling Handover Measurement in a Discontinuous Reception Mode and Related Communication Device

(76) Inventor: Chih-Hsiang Wu, Taoyuan County (TW)

(21) Appl. No.: 12/900,448

(22) Filed: Oct. 7, 2010

Related U.S. Application Data
(60) Provisional application No. 61/256,312, filed on Oct. 30, 2009.

(51) Int. Cl. H04W 36/00

(52) U.S. Cl. 455/436

(57) ABSTRACT

A method of handling measurement in a DRX mode is for a mobile device in a wireless communication system. The method comprises being requested to perform inter-frequency measurement or inter-radio access technology (RAT) measurement after the mobile device performs a handover procedure or a re-establishment procedure and performing the inter-frequency measurement or inter-RAT measurement when the mobile device stays in a DRX period of the DRX mode.

### CROSS REFERENCE TO RELATED APPLICATIONS

This application claims the benefit of U.S. Provisional Application No. 61/256,312, filed on Oct. 30, 2009 and entitled “Methods to measure neighboring cells in wireless communications system” the contents of which are incorporated herein in their entirety.

### BACKGROUND OF THE INVENTION

1. Field of the Invention

A method and related communication device for a wireless communication system is disclosed, and more particularly to, a method and related communication device for handling measurement in a discontinuous reception mode in a wireless communication system.

2. Description of the Prior Art

A long-term evolution (LTE) system, initiated by the third generation partnership project (3GPP), is now being regarded as an evolved 3G (third generation) radio interface and radio network architecture that provides a high data rate, low latency, packet optimization, and improved system capacity and coverage. In the LTE system, an evolved universal terrestrial radio access network (E-UTRAN) includes a plurality of evolved Node-Bs (eNBs) and communicates with a plurality of mobile devices, also referred as user equipments (UEs).

When the UE moves, propagation conditions from different eNBs to the UE change rapidly. Therefore, in order to maintain service continuity, the UE must not only be connected to a serving cell but importantly also monitor neighbor cells. Further, the UE provides measurements of neighbor cells to the network and then the network may request the UE to perform mobility decision (e.g. a handover procedure or a cell reselection procedure) towards other eNBs of the same radio access technology (RAT)/the different RATs to reach the goal of the service continuity with a given preference criterion (e.g. quality of service (QoS), cost or network operator).

In the LTE system, a logical connection between the UE and the E-UTRAN is defined by radio resource control (RRC) connection states. The RRC connection states of the UE contain an RRC_IDLE state and an RRC_CONNECTED state. Mobility control in RRC_IDLE is UE-controlled (e.g. the cell reselection procedure) whereas in RRC_CONNECTED it is controlled by the E-UTRAN. Therefore, the UE in RRC_IDLE state monitors a paging channel for detecting an incoming call and receives the system information for controlling the cell (re)selection procedure. The UE in RRC_CONNECTED state receives the system information in order to provide measurements of neighboring cells to enable the E-UTRAN for selecting the most appropriate cell for the UE. The measurement of neighboring cells may include an inter-frequency measurement for different frequencies on one RAT (e.g. different eNBs in E-UTRAN), an inter-RAT measurement for different RATs, e.g. between the eNB in the LTE system and the Node-B (NB) in a universal mobile telecommunications system (UMTS) system or between the eNB in the LTE system and the base station in a global system for mobile communications (GSM) system or reading system information of an inter-frequency cell or an inter-RAT cell. When the UE performs the inter-frequency measurement or the inter-RAT measurement, a measurement gap should be assigned by the E-UTRAN. The measurement gap is a time period with no uplink and downlink transmission between the E-UTRAN and the UE. Therefore, the UE can perform the inter-frequency measurement or inter-RAT measurement and report the measurement results to the E-UTRAN. Further, the E-UTRAN may take into account not only the radio link quality but factors such as UE capability, subscriber type and access restrictions. Then the E-UTRAN controls the UE in RRC_CONNECTED state for deciding to which cell the UE should perform the handover procedure or the re-establishment procedure in order to maintain the radio link and preserve service continuity.

In order to save the battery lifetime of the UE, the UE in RRC_CONNECTED state may be configured with a discontinuous reception (DRX) mode by the E-UTRAN. The DRX mode can be regarded as a DRX cycle divided into ‘on duration’ and ‘DRX period’. During ‘on duration’, the UE monitors a physical downlink control channel (PDCCH), whereas during ‘DRX period’, the UE deactivate the reception of the PDCCH to save the battery consumption.

However, without considering the interaction between the inter-frequency measurement/inter-RAT measurement and the DRX mode, several scenarios are described as follows.

In the first scenario, after the UE performs the handover procedure, or the re-establishment procedure and the E-UTRAN configures the DRX mode but does not configure the measurement gap to the UE, the UE may not perform the inter-frequency measurement or the inter-RAT measurement during the DRX period of DRX mode because the UE does not have the measurement gap. In this situation, the E-UTRAN may still expect the UE to report results of the inter-frequency measurement or the inter-RAT measurement. However, the UE does not make any measurement report since no inter-frequency/inter-RAT measurement is performed. Due to no measurement reported by the UE, the E-UTRAN cannot request the UE to perform the inter-frequency handover procedure or the inter-RAT handover procedure, and thus a radio link failure problem may occur since the handover procedure cannot be prepared for the appropriate cell.

In the second scenario, the E-UTRAN configures the DRX mode to the UE, there is no clear regulation in the LTE specification to specify whether the UE should perform the inter-frequency measurement or the inter-RAT measurement in the DRX period of the DRX mode. If the E-UTRAN may expect the UE to report the inter-frequency measurement or the inter-RAT measurement but the UE does not perform corresponding measurements, the E-UTRAN cannot request the UE to perform the inter-frequency handover procedure or the inter-RAT handover procedure and a radio link failure problem may occur. On the other side, if the E-UTRAN may not expect the UE to report the inter-frequency measurement or the inter-RAT measurement but the UE performs corresponding measurements, the UE wastes the battery power consumption to switching on the receiver for corresponding measurements.

### SUMMARY OF THE INVENTION

A method and related device for handling measurement in a discontinuous reception (DRX) mode in a wireless communication system is disclosed to solve the abovementioned problems.

A method of handling measurement in a DRX mode for a mobile device in a wireless communication system is disclosed. The method comprises being requested to perform inter-frequency measurement or inter-radio access technology (RAT) measurement after the mobile device performs a handover procedure or a re-establishment procedure and performing the inter-frequency measurement or inter-RAT measurement when the mobile device stays in a DRX period of the DRX mode.

A method of handling measurement in DRX mode for a mobile device in a wireless communication system is disclosed. The method comprises being requested to perform inter-frequency measurement or inter-RAT measurement and not performing inter-frequency measurement or inter-RAT measurement when the mobile device stays in a DRX period of the DRX mode.

A communication device of a wireless communication system for handling measurement in a DRX mode is disclosed. The communication device comprises means for being requested to perform inter-frequency measurement or inter-RAT measurement after the mobile device performs a handover procedure or a re-establishment procedure and performing the inter-frequency measurement or inter-RAT measurement when the mobile device stays in a DRX period of the DRX mode.

A communication device of a wireless communication system for handling measurement in DRX mode is disclosed. The communication device comprises means for being requested to perform inter-frequency measurement or inter-RAT measurement and not performing inter-frequency measurement or inter-RAT measurement when the mobile device stays in a DRX period of the DRX mode.

These and other objectives of the present disclosure will no doubt become obvious to those of ordinary skill in the art after reading the following detailed description of the preferred example that is illustrated in the various figures and drawings.

### BRIEF DESCRIPTION OF THE DRAWINGS

FIG. 1 is a schematic diagram of an exemplary wireless communication system.

FIG. 2 is a schematic diagram of an exemplary communication device.

FIG. 3 and FIG. 4 are flowcharts of exemplary processes for handling measurement in a discontinuous reception mode.

### DETAILED DESCRIPTION

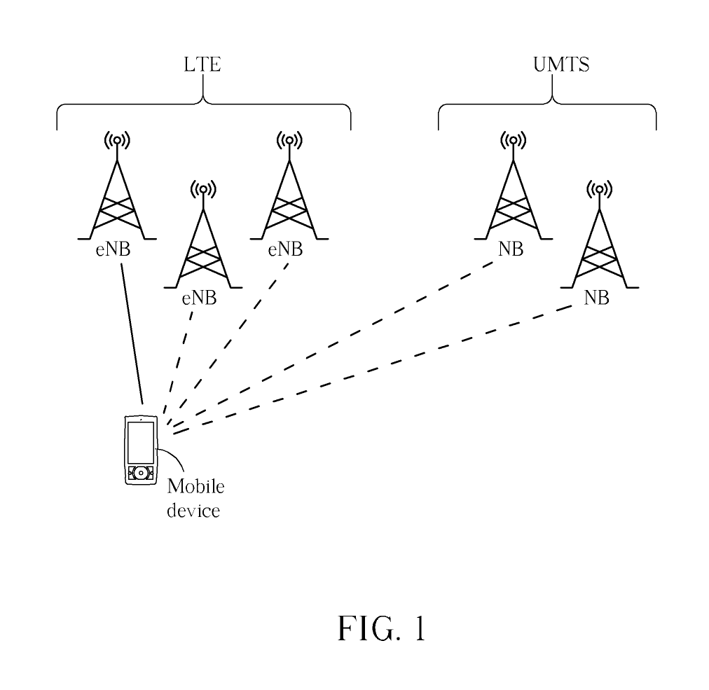

Please refer to FIG. 1, which illustrates a schematic diagram of a wireless communication system 10 according to an example. Briefly, the wireless communication system 10 is composed of a plurality of networks and a mobile device. The wireless communication system 10 can be a combination among a UMTS (Universal Mobile Telecommunications System), an LTE (long-term evolution) system or any other similar network system (only the combination of the UMTS and LTE is shown in FIG.1). In the UMTS system, the network is referred as a UTRAN (universal terrestrial radio access network) comprising a plurality of NBs (Node-Bs), whereas the mobile devices are referred as to user equipments (UEs). In the LTE system, the network is referred as an E-UTRAN (evolved-UTRAN) comprising a plurality of eNBs (evolved NBs) controlling cells, whereas the mobile devices are also referred as to UEs. In FIG. 1, a connection that has been established with one of eNBs is represented by a solid line. Further, the UE may monitor other eNBs in LTE system and also NBs in UMTS system. The monitoring behavior of the UE for the eNBs/NBs is represented by dash lines. When the UE performs the measurement between different eNBs in LTE system, such measurement is called inter-frequency measurement. When the UE performs the measurement between the eNB in LTE system and the NB in UMTS system, such measurement is called inter-radio access technology (RAT) measurement. The UEs can be devices such as mobile phones, computer systems, etc. This terminology will be used throughout the application for ease of reference, however, this should not be construed as limiting the disclosure to any one particular type of network. The network and the UE may be seen as a transmitter or receiver according to transmission direction, e.g., for uplink (UL), the UE is the transmitter and the network is the receiver, and for downlink (DL), the network is the transmitter and the UE is the receiver.

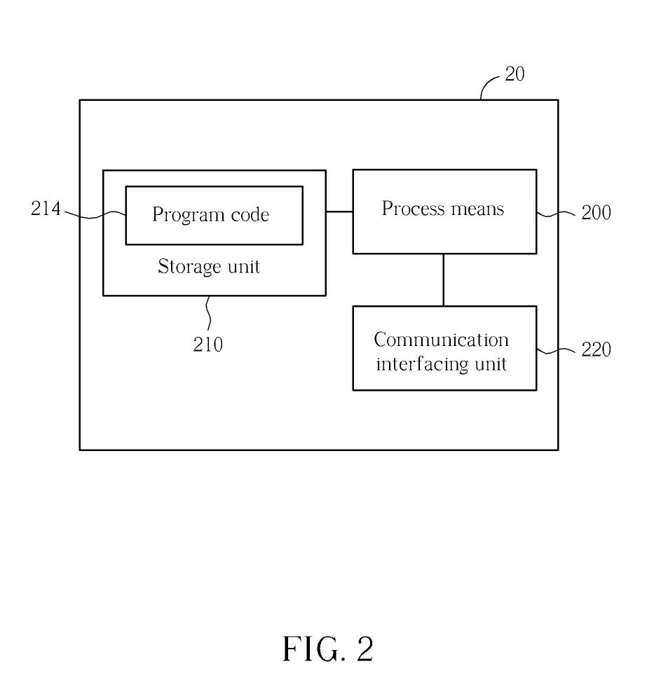

FIG. 2 illustrates a schematic diagram of an exemplary communication device 20. The communication device 20 can be the mobile device or the network shown in FIG. 1. The communication device 20 may include a processing means 200 such as a microprocessor or Application Specific Integrated Circuit (ASIC), a storage unit 210 and a communication interfacing unit 220. The storage unit 210 may be any data storage device that can store program code 214, for access by the processing means 200. Examples of the storage unit 210 include but are not limited to a subscriber identity module (SIM), read-only memory (ROM), random-access memory (RAM), CD-ROMs, magnetic tapes, hard disks, and optical data storage devices. The communication interfacing unit 220 is preferably a radio transceiver and can exchange wireless signals with the network according to processing results of the processing means 200.

When the UE is configured with a discontinuous reception (DRX) mode, the UE may monitor a physical downlink control channel (PDCCH) in an ‘on duration’ of the DRX mode and deactivate the PDCCH reception in a ‘DRX period’ of the DRX mode. Before the UE performs an inter-frequency measurement or an inter-RAT measurement, the system information of the network is necessary to read in order to get enough information among neighboring cells with which the UE can report the inter-frequency measurement or inter-RAT measurement results to the network.

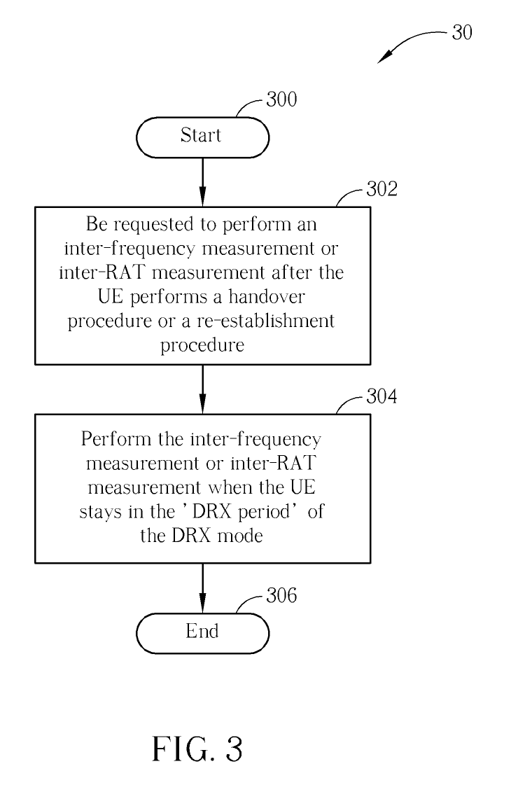

Please refer to FIG.3, which is a flowchart of an exemplary process 30. The process 30 is used for handling measurement in a discontinuous reception (DRX) mode for a UE in a wireless communication system. The process 30 may be compiled into the program code 214 and includes the following steps:

Step 300: Start.

Step 302: Be requested to perform an inter-frequency measurement or inter-radio access technology (RAT) measurement after the UE performs a handover procedure or a re-establishment procedure.

Step 304: perform the inter-frequency measurement or inter-RAT measurement when the UE stays in the ‘DRX period’ of the DRX mode.

Step 306: End.

According to the process 30, when the UE is requested to perform inter-frequency measurement or inter-RAT measurement after the UE performs the handover procedure or the re-establishment procedure, the UE performs the inter-frequency measurement or inter-RAT measurement even during the ‘DRX period’. Therefore, when the network requests the UE to perform the inter-frequency measurement or inter-RAT measurement to prepare the corresponding handover procedures, the UE always can provide the reports of inter-frequency measurement or inter-RAT measurement to the network. Thus, the process 30 can avoid the radio link failure problem caused by a handover procedure for which no abovementioned measurement report is made for the network to determine an appropriate cell.

In addition, a measurement gap may be assigned to the UE in order to perform the inter-frequency measurement or inter-RAT measurement. When the UE is connected with the network, the uplink and downlink transmission is necessary between the UE and the network. Therefore, the measurement gap is a time period with no uplink and downlink transmission, during which the UE performs the inter-frequency measurement or inter-RAT measurement. Therefore, if the network requests the UE to perform the inter-frequency measurement or inter-RAT measurement and also assigns a measurement gap for the UE, the UE utilizes the measurement gap to perform the corresponding measurement and reports the results to the network. However, when the network does not assign any measurement gap to the UE and still asks the UE to perform the inter-frequency measurement or inter-RAT measurement, if a measurement gap have been assigned to the UE before the UE performs the handover procedure or the re-establishment procedure, the UE utilizes the ‘DRX period’ of the DRX mode to perform the inter-frequency measurement or inter-RAT measurement and reports the results to the network.

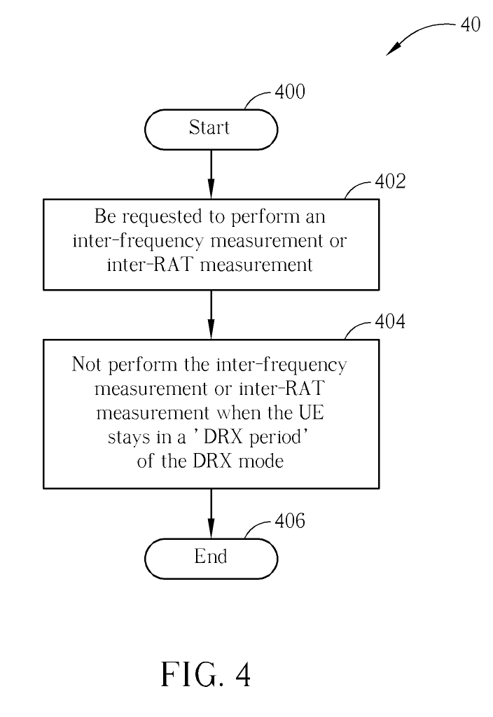

Please refer to FIG.4, which is a flowchart of a process 40 according to an example. The process 40 is used for handling measurement in a DRX mode for a UE in a wireless communication system. The process 40 may be compiled into the program code 214 and include the following steps:

Step 400: Start.

Step 402: Be requested to perform an inter-frequency measurement or inter-RAT measurement.

Step 404: Not perform the inter-frequency measurement or inter-RAT measurement when the UE stays in a ‘DRX period’ of the DRX mode.

Step 406: End.

According to the process 40, when the UE in the ‘DRX period’ is requested to perform the inter-frequency measurement or inter-RAT measurement, the UE may not perform the inter-frequency measurement or inter-RAT measurement. Further, the UE may determine whether the network assigns a measurement gap to the UE after the UE performs a handover procedure or a re-establishment procedure. At this moment, if the UE stays in the ‘DRX period’ and no measurement gap is assigned to the UE, the UE may not perform the inter-frequency measurement or inter-RAT measurement. Further, the UE may switch off at least one receiver during the ‘DRX period’.

Please note that, the abovementioned steps of the processes including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20.

In conclusion, the examples as mentioned above provide ways of how to handle the inter frequency measurement and inter-RAT measurement in the DRX mode so that the UE can perform inter-frequency measurement or inter-RAT measurement appropriately for the preparation of the corresponding handover which keeps the wireless service continuity. Further, if the UE determines not to perform the requested measurement during the ‘DRX period’, switching off at least one receiver of the UE can save the power consumption.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method of handling measurement in a discontinuous reception (DRX) mode for a mobile device in a wireless communication system, the method comprising:
being requested to perform inter-frequency measurement or inter-radio access technology (RAT) measurement after the mobile device performs a handover procedure or a re-establishment procedure; and
performing the inter-frequency measurement or inter-RAT measurement when the mobile device stays in a DRX period of the DRX mode.

2. The method of claim 1, wherein performing the inter-frequency measurement or inter-RAT measurement when the mobile device stays in the DRX period of the DRX mode comprises:
performing the inter-frequency measurement or inter-RAT measurement when the mobile device stays in the DRX period of the DRX mode and is not assigned a measurement gap for the inter-frequency measurement or inter-RAT measurement.

3. A method of handling measurement in discontinuous reception (DRX) mode for a mobile device in a wireless communication system, the method comprising:
being requested to perform inter-frequency measurement or inter-radio access technology (RAT) measurement; and
not performing inter-frequency measurement or inter-RAT measurement when the mobile device stays in a DRX period of the DRX mode.

4. The method of claim 3 further comprising:
determining whether a measurement gap is assigned to the mobile device after the mobile device performs a handover procedure or a re-establishment procedure ; and
not performing the inter-frequency measurement or inter-RAT measurement when the mobile device stays in the DRX period of the DRX mode comprises:
not performing the inter-frequency measurement or inter-RAT measurement when the mobile device stays in the DRX period and determines that no measurement gap is assigned to the mobile device after the mobile device performs a handover procedure or a re-establishment procedure.

5. The method of claim 3 further comprising switching off at least a receiver of the mobile device during the DRX period.

6. A communication device of a wireless communication system for handling measurement in a discontinuous reception (DRX) mode, the communication device comprising:
means for being requested to perform inter-frequency measurement or inter-radio access technology (RAT) measurement after the mobile device performs a handover procedure or a re-establishment procedure; and
means for performing the inter-frequency measurement or inter-RAT measurement when the mobile device stays in a DRX period of the DRX mode.

7. The communication device of claim 6, wherein means for performing the inter-frequency measurement or inter-RAT measurement when the mobile device stays in the DRX period of the DRX mode comprises:
means for performing the inter-frequency measurement or inter-RAT measurement when the mobile device stays in the DRX period of the DRX mode and is not assigned a measurement gap for the inter-frequency measurement or inter-RAT measurement.

8. A communication device of a wireless communication system for handling measurement in discontinuous reception (DRX) mode, the communication device comprising:
means for being requested to perform inter-frequency measurement or inter-radio access technology (RAT) measurement; and
means for not performing inter-frequency measurement or inter-RAT measurement when the mobile device stays in a DRX period of the DRX mode.

9. The communication device of claim 8 further comprising:
means for determining whether a measurement gap is assigned to the mobile device after the mobile device performs a handover procedure or a re-establishment procedure; and
wherein means for not performing the inter-frequency measurement or inter-RAT measurement when the mobile device stays in the DRX period of the DRX mode comprises:
means for not performing the inter-frequency measurement or inter-RAT measurement when the mobile device stays in the DRX period and determines that no measurement gap is assigned to the mobile device after the mobile device performs a handover procedure or a re-establishment procedure.

10. The communication device of claim 8 further comprising means for switching off at least a receiver of the mobile device during the DRX period.
